(19) United States
(12) Patent Application Publication
(10) Pub. No.: US 2003/0169465 A1
(43) Pub. Date: Sep. 11, 2003

(54) Image-scanning device

(75) Inventors: Ming-Tsung Cheng, Taipei (TW); Fang-Chieh Lu, Taipei (TW)

Correspondence Address: Quintero Law Office, 3rd Floor, 1617 Broadway, Santa Monica, CA, 90404, US

(73) Assignee: BENQ Corporation

(21) Appl. No.: 10/385,027

(22) Filed: Mar. 10, 2003

(30) Foreign Application Priority Data
Mar. 11, 2002 (TW) 91104505

(51) Int. Cl. H04N 1/04

(52) U.S. Cl. 358/474

(57) ABSTRACT

An image-scanning device having selectively powered elements. The device includes a light source for lighting an object, an image sensor for retrieving image of the object, a motor for moving the sensor to scan the object, and a power-assigning device for alternately supplying electric power to the light source and the motor.

### BACKGROUND OF THE INVENTION

1. Field of the Invention

The present invention relates in general to an image-scanning device, and particularly to an image-scanning device having selectively powered elements to conserve supplied power.

2. Description of the Related Art

Referring to FIG. 1, a conventional image-scanning device such as a scanner or a fax machine, includes a fluorescent tube (or light emitting diodes, LEDs) 111 for lighting the scanned object, a charge-coupled device (CCD) (or contact image sensor, CIS) 112 for retrieving image of the object, a step motor 113 for moving the CCD/CIS 112 to scan the object, and a main circuit 114 for managing all of the elements of the image-scanning device.

Referring to FIG. 1, the linear/switching regulators 115 and 117 are used for stabilizing the voltage output to the fluorescent tube/LEDs 111 and the CCD/CIS 112, respectively. The image-scanning device can therefore have no linear/switching regulators 115, 117 in case the voltage supplied by the DC power supply 110 is already stable. The DC-AC inverter 116 is used for converting direct current into alternating current. If the element 111 is a fluorescent tube, using alternating current, then the DC-AC inverter 116 is required for the image-scanning device. If the element 111 represents a plurality of LEDs, which use direct current, then the image-scanning device can have no DC-AC inverter 116. The DC-DC converter 118 is used for reducing the voltage output to the main circuit 114. If the elements 119, 120 are linear regulators, then the DC-DC converter 118 is required for the image-scanning device. If the elements 119, 120 are switching regulators, which are able to sufficiently reduce and stabilize the voltage for the main circuit 114, then the DC-DC converter 118 can be omitted.

The fluorescent tube/LEDs 111 and the CCD/CIS 112 provide no function but still consume electric power while the step motor 113 operates. On the other hand, the step motor 113 does not operate but the driving circuit of the step motor still consumes electric power, while the fluorescent tube/LEDs 111 and the CCD/CIS 112 operate. It is concluded that a conventional image-scanning device during operation continually uses a current Iᵢₙ=I₁+I₂+I₃+I₄, a part of which is not actually required and the electric power is thus wasted.

A universal serial bus (USB) is able to supply an output current of 0.5A. However, a conventional image-scanning device generally is connected to a standard indoor outlet instead of a USB, because 0.5A is not sufficient for a conventional image-scanning device.

### SUMMARY OF THE INVENTION

An object of the present invention is to provide an image-scanning device having selectively powered elements to conserve supplied power.

Another object of the present invention is to provide an image-scanning device able to operate using the electric power supplied by a USB.

The image-scanning device of the present invention includes a light source for lighting an object, an image sensor for retrieving image of the object, a motor for moving the sensor to scan the object, and a power-assigning device for alternately supplying electric power to the light source and the motor.

### BRIEF DESCRIPTION OF THE DRAWINGS

The present invention can be more fully understood by reading the subsequent detailed description and examples with references made to the accompanying drawings, wherein:

FIG. 1 is a block diagram of a conventional image-scanning device;

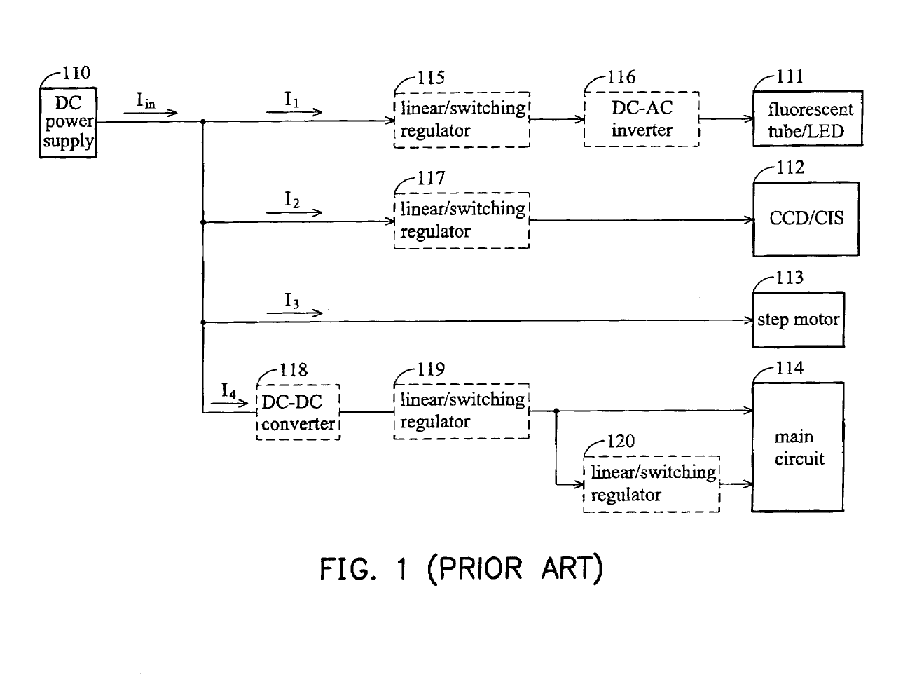

FIG. 2 is a block diagram of the image-scanning device in accordance with a first embodiment of the present invention; and

FIG. 3 is a block diagram of the image-scanning device in accordance with a second embodiment of the present invention.

### DETAILED DESCRIPTION OF THE PREFERRED EMBODIMENT

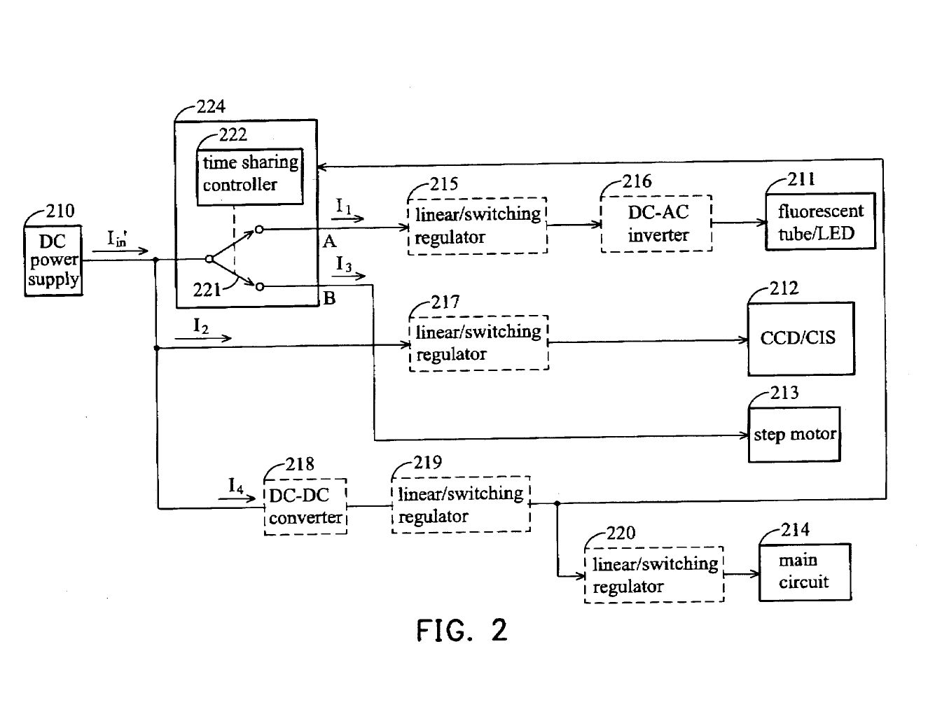

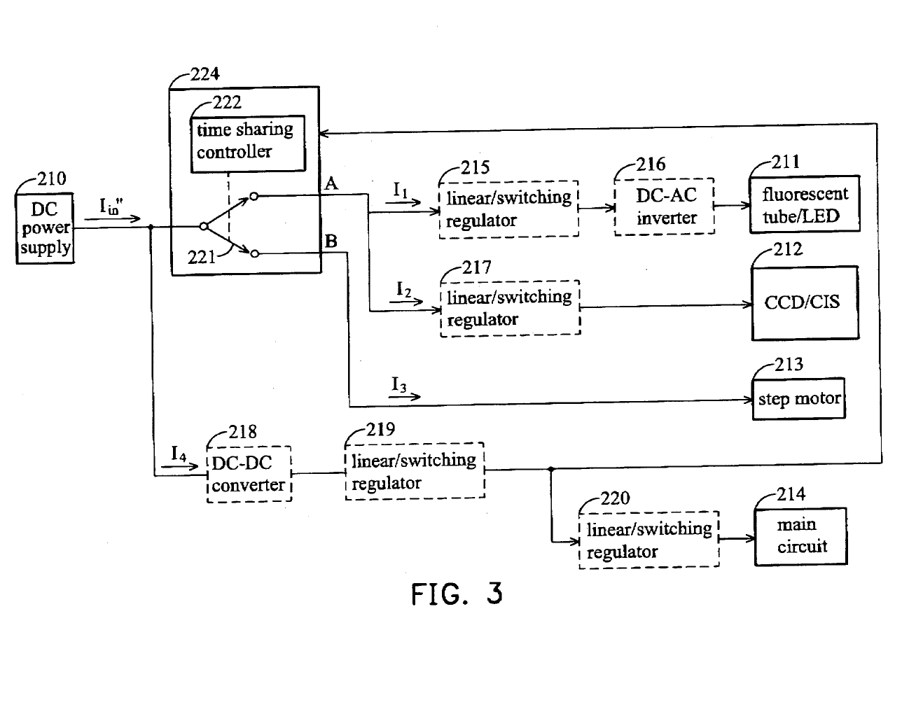

An image-scanning device of the present invention can be a scanner, a fax machine or other devices. FIG. 2 is a block diagram of the image-scanning device in accordance with a first embodiment of the present invention, while FIG. 3 is a block diagram in accordance with a second embodiment. Referring to FIGS. 2 or 3, the image-scanning device of the present invention includes a power-assigning device 224, an image sensor 212, a light source 211 and a motor 213. The power-assigning device 224 has a first output terminal A and a second output terminal B, and is coupled to an external power supply 210 for selectively outputting electric power to only one of the first output terminal A and the second output terminal B. Either of the image sensor 212 or the light source 211 is coupled to the first output terminal A of the power-assigning device. The image sensor 212 is used for retrieving image of the object to be scanned, while the light source 211 is used for lighting the object. The motor 213 is coupled to the second output terminal B of the power-assigning device 224 for moving the image sensor 212 with respect to the object. By this arrangement, the light source 211 and the motor 213 alternately consume electric power.

The first and second embodiments are introduced in detail as follows:

Referring to FIG. 2, the image-scanning device of the first embodiment of the present invention includes a fluorescent tube (or light emitting diodes, LEDs) 211 for lighting the object to be scanned, a charge-coupled device (CCD) (or contact image sensor, CIS) 212 for retrieving image of the object, a step motor 213 for moving the CCD/CIS to scan the object, and a main circuit 214 for managing all of the other elements of the image-scanning device.

The linear/switching regulators 215, 217 are used for stabilizing the voltage output to the fluorescent tube/LEDs 211 and the CCD/CIS 212, However, the linear/switching regulators 215, 217 can be removed from the image-scanning device, in case the voltage supplied by the DC power supply 210 is already very stable. The DC-AC inverter 216 is used for converting direct current into alternating current. If the light source 211 is a fluorescent tube, using alternating current, then the DC-AC inverter 216 is required. If the light source 211 includes a plurality of LEDs, using direct current, then the image-scanning device can have no DC-AC inverter 216. The DC-DC converter 218 is used for reducing the voltage output to the main circuit 214. If the elements 219, 220 are linear regulators, then the DC-DC converter 218 is required. If the elements 219, 220 are switching regulators, which are able to sufficiently reduce and stabilize the voltage for the time sharing control 222 and main circuit 214, then the DC-DC converter 218 can be omitted.

The power-assigning device 224 has a time sharing controller 222 for controlling the switch 221 to alternately supply electric power to the fluorescent tube/LEDs 211 and the step motor 213. In detail, when the switch 221 turns on the step motor 213, the fluorescent tube/LEDs 211 shuts off, thereafter using no electric power, so that the total input current Iᵢₙ′=I₂+I₃+I₄. On the other hand, when the switch 221 turns on the fluorescent tube/LEDs 211, the step motor 213 shuts off, thereafter using no electric power, so that the total input current Iᵢₙ′=I₁+I₂+I₄. By the arrangement, the fluorescent tube/LEDs 211 and the step motor 213 are alternately turned off to reduce electric power consumption.

The first embodiment can be easily modified, wherein the CCD/CIS 212 is coupled to the first output terminal A of the power-assigning device 224, and the fluorescent tube/LEDs 211 is coupled to the DC power supply 210 directly. By this modified arrangement, the CCD/CIS 212 and the step motor 213 are alternately turned off by a similar power-assigning device to reduce electric power consumption.

FIG. 3 is a block diagram of the image-scanning device in accordance with the second embodiment of the present invention, wherein the elements the same as those of the first embodiment are given the same reference numerals and the descriptions thereof are omitted. In the second embodiment, the fluorescent tube/LEDs 211 and the CCD/CIS 212 are connected to the first output terminal A in parallel so that both simultaneously operate or stop. In detail, when the switch 221 turns on the step motor 213, the fluorescent tube/LEDs 211 and the CCD/CIS 212 shut off, thereafter using no electric power, so that the total input current Iᵢₙ″=I₃+I₄, less than the input current Iᵢₙ′=I₂+I₃+I₄ in the first embodiment. On the other hand, when the switch 221 turns on the fluorescent tube/LEDs 211 and the CCD/CIS 212, the step motor 213 shuts off, thereafter using no electric power, so that the total input current Iᵢₙ″=I₁+I₂+I₄. By the arrangement, the fluorescent tube/LEDs 211 and CCD/CIS 212 as well as the step motor 213 are alternately turned off to reduce electric power consumption.

Generally, a fluorescent tube consumes more electric power than LEDs used in the image-scanning device. In the second embodiment, therefore, the total current used by the image-scanning device may be less than 0.5A when the element 211 represents LEDs using less current than a fluorescent tube. Thus, supplying electric power to the image-scanning device 211 via a universal serial bus (USB) is feasible.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image-scanning device for scanning an object, the image-scanning device coupled to an external power supply which supplies electric power, comprising:
a power-assigning device having a first output terminal and a second output terminal, the power-assigning device selectively outputting the electric power to only one of the first output terminal and the second output terminal;
an image sensor for retrieving image of the object;
a light source coupled to the first output terminal of the power-assigning device, for lighting the object; and
a motor coupled to the second output terminal of the power-assigning device, for moving the image sensor, whereby the light source and the motor alternately consume the electric power.

2. An image-scanning device as claimed in claim 1, wherein the power-assigning device also supplies the electric power to the image sensor when supplying the electric power to the light source.

3. An image-scanning device as claimed in claim 1, wherein the power-assigning device comprises a switch and a time-sharing controller for controlling the switch to alternately supply the electric power to one of the light source and the motor.

4. An image-scanning device as claimed in claim 1, wherein the light source is a fluorescent tube.

5. An image-scanning device as claimed in claim 1, wherein the light source comprises a plurality of light-emitting diodes.

6. An image-scanning device as claimed in claim 1, wherein the image sensor is a charge-coupled device.

7. An image-scanning device as claimed in claim 1, wherein the image sensor is a contact image sensor.

8. An image-scanning device as claimed in claim 1, wherein the motor is a step motor.

9. An image-scanning device for scanning an object, the image-scanning device coupled to an external power supply which supplies electric power, comprising:
a light source for lighting the object;
a power-assigning device having a first output terminal and a second output terminal, the power-assigning device selectively outputting the electric power to only one of the first output terminal and the second output terminal;
an image sensor coupled to the first output terminal of the power-assigning device, for retrieving image of the object; and
a motor coupled to the second output terminal of the power-assigning device, for moving the image sensor, whereby the image sensor and the motor alternately consume the electric power.

10. An image-scanning device as claimed in claim 9, wherein the power-assigning device also supplies the electric power to the light source when supplying the electric power to the image sensor.

11. An image-scanning device as claimed in claim 9, wherein the power-assigning device comprises a switch and a time-sharing controller for controlling the switch to alternately supply the electric power to one of the image sensor and the motor.

12. An image-scanning device as claimed in claim 9, wherein the motor is a step motor.
